(19) United States
(12) Patent Application Publication
(10) Pub. No.: US 2008/0087860 A1
(43) Pub. Date: Apr. 17, 2008

(54) Valve assembly and system

(76) Inventors: Michael Vaillancourt, Oak Ridge, NJ (US); Robert Aulicino, Oak Ridge, NJ (US); James Nisler, Oak Ridge, NJ (US)

Correspondence Address: PATENT DOCKET ADMINISTRATOR;LOWENSTEIN SANDLER PC, 65 LIVINGSTON AVENUE, ROSELAND, NJ, 07068, US

(21) Appl. No.: 11/581,599

(22) Filed: Oct. 16, 2006

(51) Int. Cl. F16K 31/44

(52) U.S. Cl. 251/225

(57) ABSTRACT

A valve assembly and system designed to enable an operator to withdraw a sample of a liquid from a source, typically for collection in a collection vessel. The valve assembly includes a valve housing, a sleeve secured to the valve housing and having an inner surface being at least partially threaded for mating with a threaded section disposed on the valve stem body. The valve stem has an internal longitudinal bore, a sealing boot, circumferential seals, and openings to the bore, and is movable between an open position (wherein the fluid flows from the source through the valve assembly) and a closed position (wherein the valve stem prevents the fluid from flowing from the source into the valve assembly).

### FIELD OF THE INVENTION

The present invention relates to a valve assembly for withdrawing a sample of a material from a source, typically for collection in a collection vessel for testing purposes. Alternatively, the valve assembly may be used in applications where the passage of a fluid from one vessel or system to another is desired.

### BACKGROUND OF THE INVENTION

Many biotech and pharmaceutical applications require the collection of periodic samples of a liquid, suspension or other fluid from a storage or process vessel for analysis or testing. In many such instances, the material being stored or processes is of a highly pure, sterile or uncontaminated nature, and great care must be taken in the sampling procedure to avoid exposure of the material to the environment to prevent contamination of, and/or the unwanted introduction of impurities to, the drawn sample or the material being stored or processed. Conversely, such isolation may be desired when the material involved is of a toxic or bio-hazardous nature, and it is desired that such material be prevented from escaping into the environment or from coming into contact with system operators.

Existing technologies and devices directed to the collection of material samples have limitations due to the requirement of complicated assemblies comprising stainless valves, separate containers, filters, fittings, syringes, and tubing, often obtained from separate component suppliers. Most conventional designs and assemblies require an extensive amount of labor to create, clean, operate, document and confirm the cleanliness of the products. In addition, such systems are often bulky and cumbersome.

Furthermore, because these conventional devices are comprised of a number of parts and include a number of joints and coupling points, small recesses or crevices are formed which entrap the material, causing areas of potential contamination. Standard, re-usable components also require post-procedure cleaning, maintenance, and set-up. Any time these steps are performed, the potential for error increases, particularly in the case where the operator lacks experience in handling the device or system.

Other conventional technologies employ needles to extract or draw the desired sample. However, the use of such needles can compromise safety to the operator and could contaminate the process. Still other designs require a complex compilation of multiple soft, elastomer seals and rigid components.

Accordingly, a need exists for a compact device which enables the easy, safe and aseptic extraction of a sample from a sealed system and is simple to operate and clean.

### SUMMARY OF THE INVENTION

Embodiments of the present invention satisfy these and other needs by providing an aseptic valve assembly for controlling the flow of a material from a source or source to a collection vessel.

According to an embodiment of the present invention, the valve assembly comprises easily coupled components which provide for a sealed, recess-free channel for the aseptic withdrawing of material from a source system or vessel. In operation, the valve assembly may be used to control the flow of a fluid from a source to an appropriate collection vessel (e.g., a container, pouch, tube, etc.) by means of a pressure differential. Advantageously, the valve assembly provides a sterile and stable channel for the flow of a sample fluid to a collection vessel, where the sample fluid may be used for testing purposes.

According to an embodiment of the present invention, the valve assembly comprises a valve housing including a housing face adapted to attach to a source; a sleeve fixedly secured to the valve housing; a hollow valve stem body threadedly mated with sleeve. The valve assembly may further comprise a tubing subassembly attached to the valve stem which provides fluid communication between the valve stem and a collection vessel, and a valve stem cap engaged to the valve stem body which secures the connection between the tubing and the valve stem.

According to an embodiment of the present invention, the valve housing, which interfaces and couples with the source system (either directly or via an intermediary component such as a sanitary clamp or fitting, including without limitation, a tri-clamp), includes a housing face configured to allowing for a flush, contamination-point free seal between the valve assembly and the source. Advantageously, this flush seal is free from any dead leg or entrapment areas that are difficult to clean and fully sterilize.

The housing face may comprise at least one opening and a longitudinal bore in fluid communication with the housing face opening. According to an embodiment of the present invention, a cylindrical sleeve is fixedly attached to the housing body in concentric alignment with the first housing bore. The sleeve includes an inner surface being at least partially threaded to allow for a threaded engagement with an external threaded section disposed on the valve stem body.

According to an embodiment of the present invention, the valve stem body may further comprises a longitudinal bore extending through the stem body, a first end and a second end, a sealing element proximal to the first end, a first opening to the longitudinal bore, the first opening disposed in the stem body, a second opening to the longitudinal bore disposed in the second end of the stem body.

According to an embodiment of the present invention, the valve assembly may comprise at least one circumferential seal disposed around the valve stem body between the first valve stem body opening and the external threaded section. The circumferential seal is adapted to sealingly mate with the first housing body bore to seal a portion of the first housing body bore between the housing face opening and the circumferential seal when the valve stem body is inserted in the first housing bore.

Preferably, the sealing element comprises a boot, wherein the boot is composed of a flexible material such as, for example, silicone. Optionally, the at least one circumferential seal may be disposed on the boot.

According to an embodiment of the present invention, the valve assembly comprises a threading stop which restrains the valve stem body from rotating beyond a fixed point when the valve is in the open position. Optionally, the sleeve may be partially threaded such that the unthreaded portion acts as the threading stop, preventing the valve stem body from translating beyond the sleeve's threaded portion.

According to an embodiment of the present invention, the valve assembly comprises a flexible tube having a first end connected to the second end of the valve stem body. The tube includes an integral flange circumferentially molded proximal the first end of the tube such that a short unflanged end section extends from the flange to the first end of the tube. The unflanged end section is proportioned to fit snugly in the second end of the valve stem body.

According to an embodiment of the present invention, the valve assembly comprises a stem cap which includes a first end and a second end, wherein the first stem cap having an aperture sized to receive and retain the flanged tube, and wherein the second stem cap end includes an aperture sized to receive the valve stem body. In assembly, the flanged tube is inserted in the first stem cap end, and the valve stem body is inserted in the second stem cap end sufficiently to engage the stem cap and valve stem body together.

According to an embodiment of the present invention, the valve assembly may be assembled without a sleeve. In this embodiment, the valve stem including a protrusion is inserted into the housing body bore and is movable between an open position and a closed position. The valve assembly includes a stem retention element which engages with a protrusion of the valve stem to restrain the valve stem body from moving beyond a fixed point when the valve is in the open position. Optionally, the inner surface of the valve housing may be partially threaded to threadedly engage with an external threaded section disposed on the valve stem body.

According to an embodiment of the present invention, the aseptic valve assembly may be provided as a pre-sterilized and pre-assembled unit which allows the user to install the valve assembly directly to a source without pre-cleaning, sterilization, or assembly. Advantageously, the flush face of the valve housing may be cleaned during the cleaning process of the entire system. Furthermore, the components of the aseptic valve assembly act as a high pressure steam barrier to allow use of low pressure tubing and collection vessels that are downstream of the device.

### BRIEF DESCRIPTION OF THE DRAWINGS

The present invention will be more readily understood from the detailed description of exemplary embodiments presented below considered in conjunction with the attached drawings, of which:

FIG. 1 illustrates a side perspective view and a cross-sectional view of an exemplary valve assembly, according to an embodiment of the present invention;

FIG. 2 illustrates a side perspective view and a cross-sectional view of an exemplary valve housing, according to an embodiment of the present invention;

FIG. 3 illustrates a side perspective view and a cross-sectional view of an exemplary boot, according to an embodiment of the present invention;

FIG. 4 illustrates a side perspective view and a cross-sectional view of an exemplary valve stem, according to an embodiment of the present invention;

FIG. 5 illustrates a side perspective view of an exemplary tubing subassembly, according to an embodiment of the present invention;

FIG. 6 illustrates a side perspective view and a cross-sectional view of an exemplary sleeve, according to an embodiment of the present invention;

FIG. 7 illustrates a side perspective and a cross-sectional view of an exemplary valve stem cap, according to an embodiment of the present invention;

FIG. 8 illustrates an exemplary aseptic valve assembly connected to a source and a collection vessel, according to an embodiment of the present invention;

FIG. 9 illustrates an exemplary multi-port aseptic valve assembly, according to an embodiment of the present invention;

FIG. 10A is a side view of an exemplary tubing subassembly including a tapered flange, according to an embodiment of the present invention; and

FIG. 10B is a side, cross-sectional view of an exemplary valve assembly illustrating the compression seal between the valve stem and the tubing subassembly, according to an embodiment of the present invention.

It is to be understood that the attached drawings are for purposes of illustrating the concepts of the invention and may not be to scale.

### DETAILED DESCRIPTION OF THE INVENTION

The present invention relates to an valve assembly configured to facilitate the extraction of a sample of a material from a source. According to an embodiment of the present invention, the source may include, but is not limited to, any source of material from which a sample is to be extracted, such as, for example, a tank, vessel, and/or container (collectively referred to as a “source”). Further, the source may include a connector, fitting or device (e.g., a tri-clamp) for connecting the valve assembly to the source. The material extracted from the source through the aseptic valve assembly may comprise any suitable material, particularly those in the pharmaceutical, biotech, and beverage industries. For example, the material may comprise a high purity liquid or pharmaceutical composition or process intermediate.

The valve assembly provides for the safe and sterile extraction of a material sample from a sealed system in a contamination-free manner. In operation, the aseptic valve assembly assumes either an “open position” (i.e., arranged to allow the passage of the material from the source to a collection vessel) or a “closed position” (i.e., arranged such that the aseptic valve assembly does not permit the flow of material from the source system).

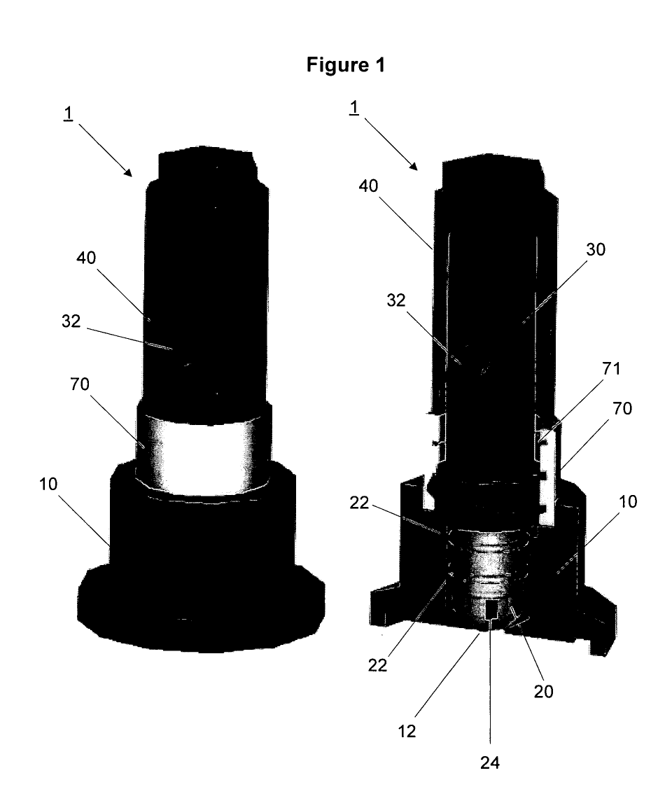

FIG. 1 illustrates an exemplary valve assembly 1. According to an embodiment of the present invention, the aseptic valve assembly 1 comprises a valve housing 10, a valve stem boot assembly including a boot 20 coupled with a valve stem 30, a valve stem cap 40, and a sleeve 70.

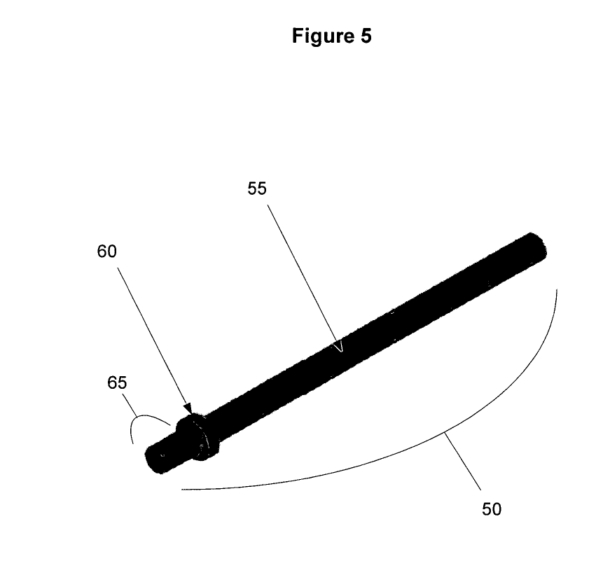

According to an embodiment of the present invention, an valve assembly system may be formed by connecting the aseptic valve assembly 1 (illustrated in FIG. 1) to a tubing subassembly 50 which includes tubing 55 having an integrally formed flange 60 (shown in FIG. 5).

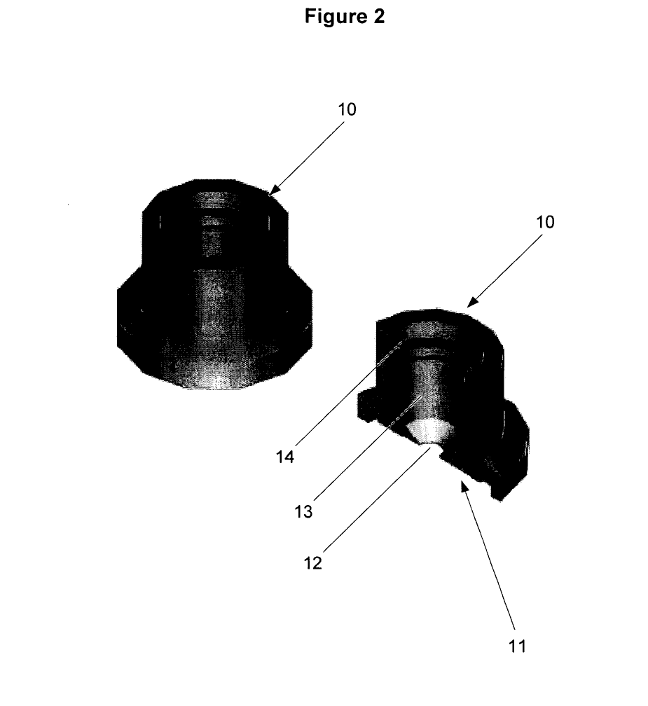

FIG. 2 illustrates a side perspective view and a cross-sectional view of an exemplary valve housing 10, according to an embodiment of the present invention. The valve housing 10 may comprise a housing face 11 adapted to attach to the source. The housing face 11 may comprise one or more openings or through-holes 12 to allow for the flow of material from the source into the aseptic valve assembly 1 when the valve 1 is in the open position.

According to an embodiment of the present invention, the valve housing 10 is shaped and sized to accept and house the boot 20 such that the boot 20 seals or plugs the opening 12 of the housing face 11 when the valve 1 is the closed position (as shown in FIG. 1). Preferably, the valve housing 10 may include an first bore 13 sized to sealingly mate with seals 22 of the boot 20 (i.e., wherein the first bore 13 has a diameter which is slightly larger than that of the boot 20 but slightly smaller than that of the seals 22). The valve housing further comprises a second larger bore 14 configured to receive the sleeve 70 and the mated valve stem 30.

The housing face 11 is shaped and dimensioned such that it may be mounted or coupled flush against the source in any manner known to those of skill in the art using any appropriate clamp, fitting or other suitable mounting hardware. This flush mounting or coupling allows for a sealed connection therebetween, which is free of any pockets, cavities, crevices, dead legs, or dead spots. One having ordinary skill in the art will appreciate that the housing face 11 may be configured to connect with any conventional source, source connector (e.g., a tri-clamp), fitting, and/or port.

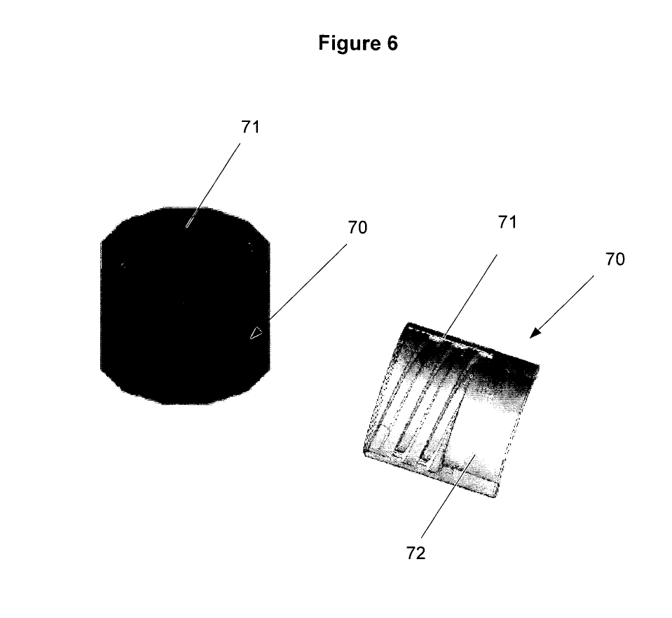

With reference to FIG. 6, the inner surface of the cylindrical sleeve 70 comprises an at least partially threaded inner surface 71. The threaded section 71 extends from one end of the sleeve 70 into the sleeve 70, but does not extend all the way through to the other end of the sleeve 70. As such, the sleeve 70 includes an unthreaded portion which acts as a threading stop 72. The threaded portion 71 is adapted to engage the corresponding external threads of the valve stem. The threading stop 72 prevents the valve stem body 30 from translating beyond a certain point, and when the inner thread end is reached, the valve stem cannot be turned any further. Thus, the threading stop 72 controls the distance that the valve stem 30 can be moved during actuation of the valve 1. In addition, the threading stop 72 ensures the operator does not over-actuate the valve 1 such that the valve stem translates out of engagement with the sleeve 70 during actuation. One having ordinary skill in the art will appreciate that the valve assembly 1 may comprise other alternative threading stops 72, such as, for example, a threaded or compression fitting, detents, or other retaining means known to those having ordinary skill in the art.

With reference to FIG. 1, the valve stem 30 is threadedly mated with the sleeve 70, and the two piece assembly is then fitted into the second bore 14 of the valve housing 10. The sleeve 71 is secured to the valve housing 10 using any suitable attachment process or material, such as, for example, adhesive or chemical bonding, by external threads on the sleeve that engage with threads internal to the valve housing bore, or any other conventional method known to those of skill in the art.

As shown in FIG. 1, the valve assembly 1 includes a valve stem boot assembly comprising the boot 20 and the valve stem 30, each of which is described in detail below.

The boot 20 is a flexible end cap adapted to attach to the valve stem 30 and fit within the valve housing 10. One having ordinary skill in the art will appreciate that the boot 20 may be composed of a strong, flexible material which provides for a robust construction such that the boot 20 is resistant to unwanted movement and does not dislodge during actuation of the valve assembly 1. The boot 20 may be composed of any suitable material, such as, for example, a plastic or elastomer. Preferably, the boot 20 is composed of silicone. Alternatively, the boot may be integrally molded as part of the valve stem 30, provided that the valve stem 30 is composed of a suitably strong yet resilient and flexible material, such as a rigid plastic or nonmetallic component as will be known to those of skill in the art.

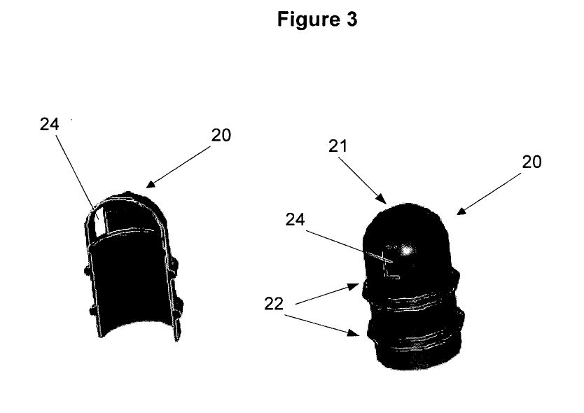

As shown in FIG. 3, preferably the boot 20 is a monolithic component configured to engage the boot mating extension 33 of the valve stem 30. The boot 20 includes an end 21 which seals or plugs the opening 12 in the housing face 11 when the valve assembly 1 is in the closed position (see FIG. 1). Upon actuation of the valve assembly 1, the boot 20 translates away from contact with the housing face 11, thereby unsealing or unplugging the opening 12 and allowing the material to freely flow therethrough.

Advantageously, according to an embodiment of the present invention, the boot end 21 is preferably rounded to provide an easy-to-clean surface and to allow for full laminar flow across the boot end 21 and the housing face 11.

According to an embodiment of the present invention, the boot 20 comprises one or more raised portions or seals 22 (e.g., integrally formed o-rings) integrally formed around the midsection of the boot 20, as shown in FIG. 3. In addition, the boot 20 includes one more opening or eyelets 24 which allow material to flow therethrough when the valve assembly 1 is in its open position. The one or more seals 22 are designed to inhibit the extraneous flow of material which escapes along the outside of the boot 20 (i.e., does not enter the one or more eyelets 24).

The one or more seals 22 are integrally molded on the outer surface of the boot 20 to provide multiple sealing points (i.e., the seal formed by the end 21 and the seal(s) formed by seals 22). Although one seal 22 may be used, preferably, at least two seals are provided, to provide redundancy and ensure extra sealing protection. The seals 22 preferably are molded as part of the boot 20, but may be added later by adhesive, mechanical or chemical bonding.

Forming the seals 22 as an integral molded part of the boot 20 has advantages, including that it eliminates the need to attach separate o-rings or attachments (e.g., gaskets and/or o-rings), thus simplifying the manufacturing process. Additionally, eliminating traditional fitted gaskets or o-rings reduces the need for retaining groove or the creation of crevices or surfaces between components where material may build up or be difficult to clean. Advantageously, the monolithic multi-seal boot 20 is easier to clean thus reducing the potential for contamination. Although shown with two seals 22, one having ordinary skill in the art will appreciate that the boot 20 may include one or any number of seals 22. This single boot design also ensures proper alignment of all seals.

According to another embodiment of the present invention (not shown in the figures), the one or more seals 22 may fit or engage with a corresponding groove or opening formed in the inner surface of the valve housing 10, to further prevent the flow of material past the seals 22. Alternatively to the seal or seals being integrally molded on the boot or valve stem, the seals may comprise conventional O-rings disposed on the value stem, or a circumferential ridge or ridges molded on or attached to the wall of the longitudinal bore of the housing body, which, when mated with the stem valve would dispose the seal(s) about the stem to form a sealed barrier.

According to an embodiment of the present invention, the boot 20 is mechanically secured to the valve stem 30 by pushing it on into place. Alternatively, one having ordinary skill in the art will appreciate that the boot 20 and the valve stem 30 may be bonded together via any conventional bonding method, including, but not limited to a chemical bonding.

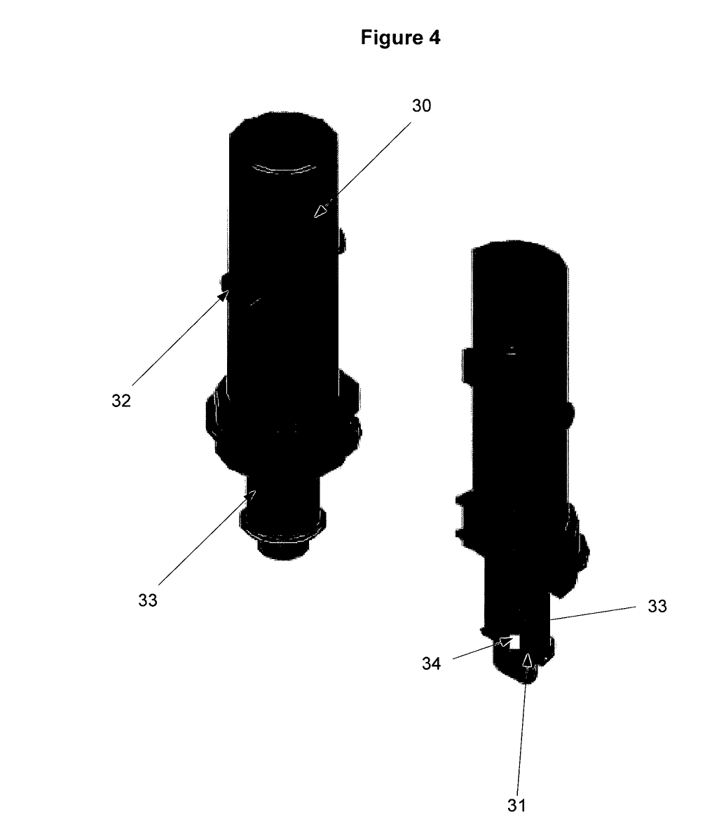

FIG. 4 illustrates an exemplary valve stem 30 according to an embodiment of the present invention. The valve stem 30 comprises a boot-mating extension 33 on which the boot 20 may be arranged. Preferably, the boot-mating extension 33 is shaped and sized such that it may be inserted within the boot 20 to provide a secure fit therebetween, such as, but not limited to, through use of a retaining shoulder or flange. Optionally, the end of the boot-mating extension 32 may be rounded to provide a compression fit with the rounded end of the boot 20. The valve stem 30 may be composed of any suitable rigid, non-flexible material, such as, for example, any suitable polymer, such as, for example, polysulfone (PS), polyetherimide (PEI), PVDF, Teflon, etc.

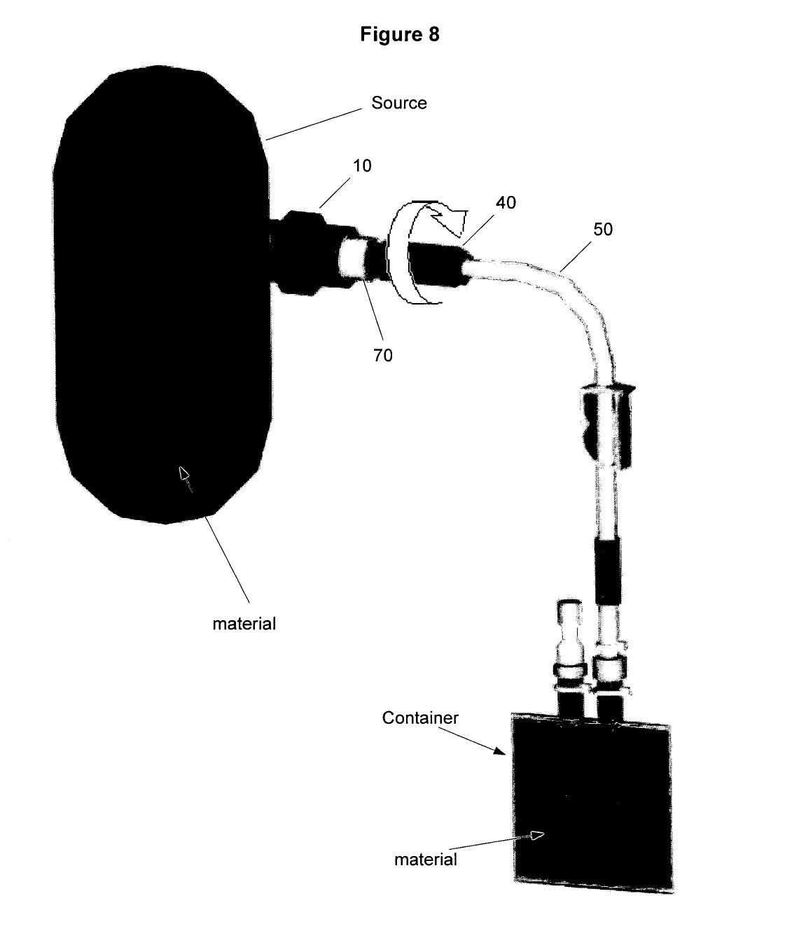

The valve stem 30 further comprises an external threaded section disposed on the valve stem body adapted to threadingly mate with the threaded portion of the sleeve 70. In operation, the threaded portion of the valve stem 30 engages with the threaded portion 71 of the sleeve 70. Upon actuation of the valve assembly 1 (i.e., turning the valve stem 30 and/or the valve stem cap 40, as shown in FIG. 8), the valve stem 30 and boot 20 (i.e., the valve stem boot assembly) translate within the threaded portion 71 (which is maintained in a fixed position due to the fastening of the sleeve 70 in the valve housing 10) to move the valve assembly 1 from the closed position to the open position, and vice versa. Due to the closed ended threads of the sleeve 70, the threaded engagement between the valve stem 30 thread and the threaded portion 71 is limited in the distance that the valve stem assembly may be rotated, to prevent over-actuation which would cause the valve assembly 1 components to disengage and come apart. Preferably, the threaded portion of the valve stem 30 comprises a fast-actuating thread for ease of operation of the valve assembly 1.

According to an alternative embodiment of the present invention, the valve assembly 1 may be configured such that the valve stem 30 is moved between its open and closed positions by a conventional push-pull actuation. In operation, the valve stem 30 may be pushed into the longitudinal bore of the valve housing body 10 to seal the housing face opening 12 and place the valve assembly in the closed position. The valve stem 30 may then be pulled away from the housing face 11 such that the seal is broken, thus placing the valve assembly 1 in the open position. One having ordinary skill in the art will appreciate that the movement of the valve stem 30 may be restrained using any suitable retaining means, including, but not limited to, an apertured cap placed over the an end of the valve stem 30 and attached to the housing body, a flange, or other structure suited for retaining a valve stem captive in a valve housing body.

According to an embodiment the valve stem 30 may be channeled 31 at its end to minimize flow turbulence and allow material to be directed and dispensed in the same direction as the valve actuation (i.e., perpendicular to the housing face 11). The boot-mating extension 33 further comprises one or more eyelets or openings 34 slightly set back from the end of the valve stem, to allow the material flowing through the eyelets 24 of the boot 20 to enter the hollow inner channel of the valve stem 30 when the valve assembly 1 is in the open position. The valve stem 30 comprises a hollow inner channel or bore to allow for the flow of material through the stem and out the other end and into the tubing subassembly 50. This through-flow rear-dispensing design enables for a more compact valve profile compared to many standard types of valve designs, such as the typical 90 degree sample valve.

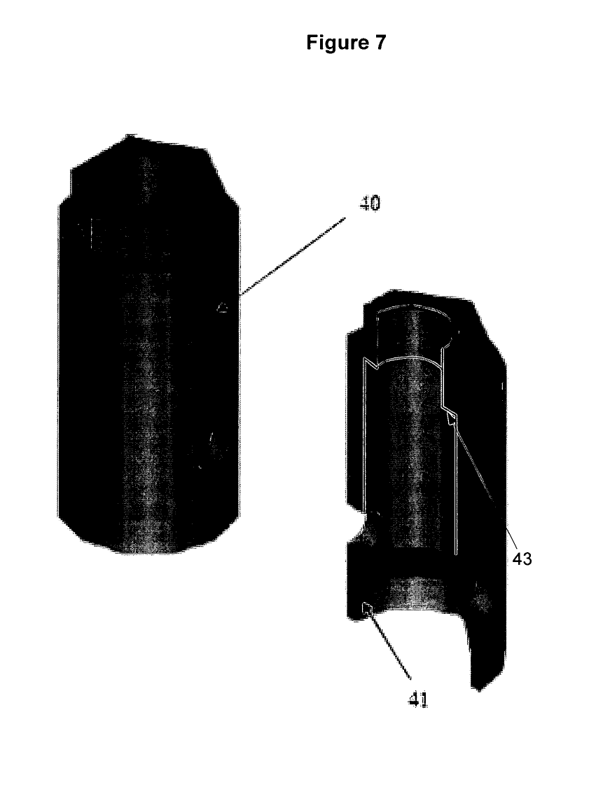

According to an embodiment of the present invention, the valve stem 30 preferably includes one or more projecting male pins 32 configured to mate with corresponding openings 42 of the valve stem cap 40 (shown in FIG. 7) to attach the valve stem 30 and the valve stem cap 40, as described in detail below. In addition, the open end of the valve stem 30 (i.e., the end opposite the boot-mating extension 33) is sized and shaped to accept and secure the tubing 55, as described in detail below. According to an alternative embodiment, the tubing 50 may be coupled to the valve stem 30 by slipping the tubing 50 over the second end of the valve stem 30.

The valve assembly 1 preferably comprises a valve stem cap 40 adapted to couple with the valve stem 30 and engage the tubing 55. According to an embodiment of the present invention, the valve stem cap 40 includes a longitudinal bore, a first end, and a second end. The first stem cap end may include an aperture or opening proportioned to receive and retain the tubing subassembly 50. The second stem cap end may include an aperture or opening proportioned to receive the valve stem body 30. Referring to FIG. 7, the valve stem cap 40 may be composed of any suitable hard, non-flexible material, such as, for example, a suitable polymer.

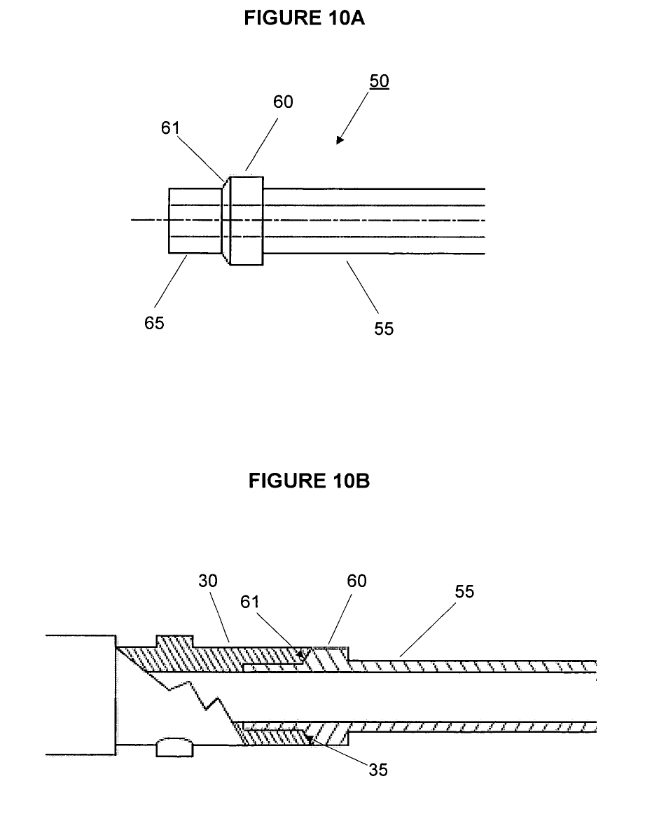

According to an embodiment of the present invention, the second end of the valve stem 30 may comprise a tapered inner surface 35 adapted to mate with a tapered surface 61 of the flange 60, as shown in FIGS. 10A and 10B. The tapered surface 35 of the valve stem 30 provides a counter bore relative to the tapered surface 61 of the flange 60 and creates a compression seal (i.e., a liquid tight seal) when the tubing 55 is inserted into the valve stem 30, as shown in FIG. 10B.

As shown in FIG. 7, the valve stem cap 40 may comprise at least one opening 42 in its side surface which is adapted to engage with an at least one male pin 32 of the valve stem 30. Optionally, the valve stem cap 40 may comprise one or more tracks adapted to guide the at least one male pin 32 into alignment with the at least one corresponding opening 42. The valve stem cap 40 may include a tapered inlet 41 with through holes on the outer diameter. Advantageously, the tapered inlet 41 allows for slight mechanical deformation of the valve stem cap 40 when being coupled to the valve stem 30. The tapered valve stem cap 40 allows for temporary deflection of the plastic material and allows the parts to mechanically engage. This mechanical joining advantageously avoids the need for solvents, welding, or adhesives to affix the valve stem cap 40 to the valve stem 30. Alternatively, the use of male pins 32 and openings 42 can be eliminated and the valve stem 30 can be joined to the valve stem cap 40 by other means known to those of skill in the art, including with adhesive, clamps, threaded coupling, or other well-known joining methods. In another embodiment, the male pin may be arranged on the inner surface of the stem cap 40 and the corresponding hole or holes may be arranged in the valve stem body 30.

In assembly, the tubing 55 including the flange 60 passes through the valve stem cap 40 and into a compression seal with the open end of the valve stem 30. Advantageously, the valve stem cap 40 protects the tubing-valve stem connection from the external environment without contacting the material during extraction. Moreover, one having ordinary skill in the art will appreciate that the location of the male pins 32 and corresponding holes 42 also controls the amount of compression sealing between the valve stem 30 and the tubing subassembly 50. Furthermore, the height of the valve stem cap 40, which abuts the sleeve 70 upon assembly, may be selected to act as a stop to avoid over-compression of the seal between the valve stem 30 and the tubing subassembly 50.

The size of the portion of the tubing 55 which is inserted into the valve stem 30 is controlled and limited by the flange 60. More specifically, the tubing 55 includes a first end adapted for connection with the second end of the valve stem body 30. As discussed above, the tubing 55 includes an integral flange 60 circumferentially molded proximal the first end of the tube such that a short unflanged end section 65 extends from the flange 60 to the first end of the tubing 55. The unflanged end section 65 is proportioned to fit snugly in the second end of the valve stem body 30.

According to an embodiment of the present invention, the valve stem cap 40 comprises a hexagon-shaped end to allow for simple opening and closing, using, for example, a correspondingly shaped and sized wrench or other tool. Alternatively, the valve stem cap 40 may be knurled or have a textured surface to allow for easy gripping. In addition, the bore through the hexagon-shaped end is preferably smaller in diameter than the bore though the main body of the valve stem cap 40, so as to create a shoulder or lip 43 in the inner channel of the valve stem cap 40. By selecting a diameter in the end bore that is the same or slightly smaller than the outer diameter of the tube 55, once the flange 60 is passed through the end bore, the tubing subassembly 50 will be securely retained such that the tubing 55 can not be pulled through and apart from the valve stem cap 40.

According to an embodiment of the present invention, the tubing subassembly 50 may be coupled between the valve stem 30 and the vessel, as shown in FIG. 8. The tubing subassembly 50 comprises the tubing 55 including a retaining flange 60. The tubing subassembly 50 is composed of a single material of construction, such as, for example, a molded elastomer material. According to an embodiment of the present invention, the flange 60 and the tubing 55 may be integrally formed using any suitable technique, such as, for example, by full molecular bonding in the silicone molding process.

The retaining flange 60 is arranged on the tubing 55 such that a portion of the tubing 55 extends past the flange, and this portion of the tubing 55 is inserted into the valve stem 30, as described above. This configuration provides for a strong mechanical coupling without the need for any adhesives.

The flange 60 eliminates the need for barbs or other similar attachment means which are typically required for mechanical seals on soft elastomer tubing. The flange 60 provides two primary functions: 1) the flange 60 allows for a compression seal with the valve stem 30; and 2) the flange 60 is shaped and sized such that it sits against the lip 43 of the valve stem cap 40 to create a compression seal therebetween which secures the tubing subassembly 50 within the valve stem cap 40.

According to an embodiment of the present invention, the diameter of the inner channel of the tubing 55 and the valve stem 30 may be the same so that there is no turbulent flow of the material.

Typical mechanical tube assemblies require a separate fitting or barb connection to secure on the soft inner walls of the elastomer tubing. This requires a separate fitting that will be slightly larger than the inside tube diameter and consequently the inner diameter of the fitting must be smaller, to account for component wall strength. As a result, the fitting acts as a flow restriction as the liquid transitions from valve to fitting to tube.

In the present invention, the valve stem 30 comprises a second end including a counter bore proportioned to accommodate the end of the tubing (i.e., the portion of the tubing which extends from the flange to the end to the tube) and allow for a linear seal. This linear seal is longitudinal along the tubing length instead of a radial compression towards the center of the tube. Advantageously, the inner diameter of the tube and the liquid flow is undisturbed.

One having ordinary skill in the art will appreciate that the valve assembly 1 may comprise the tubing assembly 50, or alternatively, a sampling system may be provided which includes a coupling of the valve assembly 1 and an tubing subassembly 50 to connect the source and the vessel (as shown in FIG. 8).

According to an embodiment of the present invention, the valve assembly 1 may be operated to move from the closed position to the open position by turning the valve stem cap 40 (e.g., a counter clockwise ¼ turn). This actuation retracts the valve stem 30 and the boot 20 such that the boot 20 moves away from the housing face 11 and no longer seals or plugs the opening 12, thus allowing for the material to flow from the source and into the first bore 13 of the valve housing 10. The material flows perpendicular to the point of connection between the valve housing 10 and the source, through the one or more openings in the boot 20, and into the valve stem 30 via the at least one valve stem opening 34. Next, the material exits the valve stem 30 and into the tubing 55. The seals 22 prevent the material being extracted from escaping from the valve housing 10. The valve assembly 1 may be shut (i.e., placed into the closed position) by turning the valve stem cap 40 in a clockwise direction. This moves the valve stem 30 and boot 20 forward (i.e., toward the source) bringing the boot end 21 into contact with the opening 12 of the valve housing 10, thus re-establishing the seal and closing off the flow path between the source and the valve assembly.

Once the material is withdrawn from the source and drawn into the collection vessel, the operator may separate the collection vessel by implementing an aseptic sealing process on the tubing 55. This may be performed according to any suitable technique known to those skilled in the art, including, but not limited to thermal welding, mechanical crimping, and/or a shut-off fitting technique.

According to an alternative embodiment of the present invention, the valve assembly 1 described in detail above may be assembled without the sleeve 70. According to this embodiment, the valve assembly 1 comprises a stem retention element attached to the body of valve housing 10 adapted to engage with a protrusion included on or attached to the valve stem body 30. In operation, the stem retention element engages with the stem protrusion to restrain the valve stem body from moving beyond a fixed point when the valve is in the open position. One having ordinary skill in the art will appreciate that the stem protrusion and stem retention element may comprise any suitable combination of interacting structural elements, including, but not limited to a collar arranged around a portion of the valve stem body, an apertured cap placed over an end of the valve stem and attached to the housing body by threads, set screw, adhesive, or other known fastening means, threads protruding from the valve stem, flanges, fittings or other structures known in the art for retaining a valve stem captive in a valve housing body. Alternative mechanically interoperable elements known to those having ordinary skill in the art may be provided in the valve assembly 1, with the important consideration being that the removal of the valve stem body 30 from the housing 10 is limited or controlled.

In yet another embodiment of the present invention, the inner surface of the valve housing 10 may include a threaded portion adapted to threadedly engage the external threaded portion of the valve stem 30, without the need for a sleeve. According to this embodiment, the valve assembly 1 comprises a threading stop to control the movement of the valve stem body 30 during actuation of the valve assembly 1. One having ordinary skill in the art will appreciate that the any suitable stopping means may be used, including, but not limited to, an apertured cap placed over an end of the valve stem or other retaining element. The cap may be attached by threads, set screw, adhesive or other fastener.

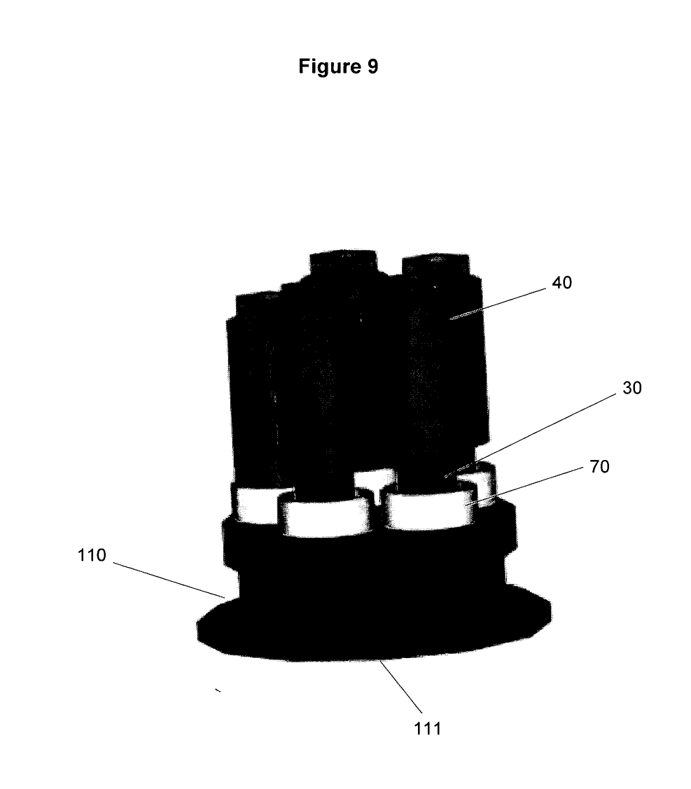

According to an embodiment of the present invention, a multi-valve assembly may be formed which comprises a valve housing having one or more openings. The multi-valve assembly, shown in FIG. 9, comprises a valve housing 110 having a plurality of longitudinal bores in fluid communication with at least one housing face opening. Each of the longitudinal bores is adapted to comprise a valve stem body 30, according to the detailed description above. Optionally, at least one of the longitudinal bores comprises a sleeve 70 fixedly attached to the valve housing 110, according to the detailed description above.

It is to be understood that the exemplary embodiments are merely illustrative of the invention and that many variations of the above-described embodiments may be devised by one skilled in the art without departing from the scope of the invention. It is therefore intended that all such variations be included within the scope of the following claims and their equivalents. In particular, the above-described invention is not intended to be limited to use in sampling or collection systems, or in applications where contamination-free operation is essential. Rather, the above-described valve assembly may be used in any suitable application where a valve is required.

1-23. (canceled)

24. A valve for controlling a flow of fluid from a source, comprising:
a valve housing comprising a housing face and a housing body, wherein the housing face is adapted to attach to a source and includes at least one opening, and the housing body comprises a longitudinal bore in fluid communication with the housing face opening;
a valve stem body disposed at least partially in the housing body bore, the valve stem body comprising a longitudinal bore extending at least partially through the stem body, a first end and a second end, a sealing element proximal the first end, a first opening to the longitudinal bore, the first opening disposed in the stem body, a second opening to the longitudinal bore disposed proximal the second end of the stem body, and a protrusion;
at least one circumferential seal disposed around the valve stem body between the first valve stem body opening and the second end, wherein the circumferential seal is adapted to sealingly mate with the housing body bore to seal from the environment a portion of the first housing body bore between the housing face opening and the circumferential seal; and
a stem retention element;
wherein the valve stem body is movable between an open position and a closed position, the valve stem sealing element is engaged with and seals the housing face opening when the valve is in the closed position, the valve stem bore is in fluid communication with the housing face opening when the valve is in the open position, and the stem retention element engages with the stem protrusion to restrain the valve stem body from moving beyond a fixed point when the valve is moved to the open position.

25. The valve of claim 24, wherein the stem protrusion comprises a collar around a portion of the valve stem body.

26. The valve of claim 24, wherein the stem retention element comprises an apertured cap placed over the second end of the valve stem with the valve stem protruding through the cap aperture, and the cap is attached to the housing body.

27-32. (canceled)

33. A valve for controlling a flow of fluid from a source, comprising:
a valve housing comprising a housing face adapted to attach to a source and having an opening, and a housing body bore;
a valve stem body disposed at least partially in the housing body bore, the stem body comprising a longitudinal bore extending at least partially through the stem body, a first end and a second end, a first opening to the longitudinal bore disposed in the stem body proximal the first end, a second opening to the longitudinal bore disposed proximal the second end of the stem body, and a protrusion;
a boot disposed on the first end of the valve stem body, the boot comprising at least one circumferential seal disposed around the boot; and
a stem retention element attached to the housing body;
wherein the valve stem body is movable between an open position and a closed position, the boot being engaged with and sealing the housing face opening when the valve is in the closed position, the valve stem bore being in fluid communication with the housing face opening when the valve is in the open position, and the stem retention element engages with the stem protrusion to restrain the valve stem body from moving beyond a fixed point when the valve stem is moved to the open position.

34-35. (canceled)

36. A system for controlling the flow of a liquid from a liquid source, the system comprising:
a. valve for controlling flow of liquid from said liquid source, said valve having an open position and a closed position, said valve comprising:
i. least one valve body, the valve body having at least one bore and a valve face, the face adjacent to said liquid source, the face comprising an opening therein providing liquid communication between the bore and said liquid source,
ii. a hollow valve stem disposed within the bore, the valve stem having a first end oriented toward the face of the valve body, and a second end opposite the first end, the valve stem reciprocating within the bore to the closed position and to the open position, the valve stem further comprising a liquid inlet adjacent to the first end and a liquid outlet adjacent to the second end, and
iii. boot covering the first end of the valve stem, said boot comprising first sealing surface adjacent to the first end of said valve stem, the boot further comprising at least one circumferential sealing surface between the liquid inlet and the liquid outlet, the circum providing a liquid tight seal between the bore and a second, sealing surface sealing the opening in the face of the valve body when said valve is in the closed position, and
b. tube comprising an integrated flange said flange disposed adjacent to the outlet of the valve stem.

37. An aseptic sampling system comprising the system for controlling the flow of liquid of claim 1.

38. The system for controlling the flow of a liquid of claim 1, in which said valve stem has tapered inner surface.

39. The system for controlling the flow of a liquid of claim 1, in which said valve body includes a restraining cap disposed over the flange of said tube and forming a liquid tight seal between the valve stem and said tube.

40. The system for controlling the flow of a liquid of claim 1, in which said boot includes multiple circumferential sealing surfaces.

41. The system for controlling the flow of a liquid of claim 1, in which said boot comprises silicone.

42. The system controlling the flow of a liquid of claim 1, in which valve body comprises multiple bores, each bore having a hollow tubular valve stem disposed therein.
